(19) United States
(12) Patent Application Publication
(10) Pub. No.: US 2024/0288536 A1
(43) Pub. Date: Aug. 29, 2024

(54) METHOD FOR DETERMINING A TRANSMISSION SIGNAL IN AT LEAST ONE RECEIVED SIGNAL

(71) Applicant: MEYSENS GMBH, Munich (DE)

(72) Inventors: Alexander RUDOY, Munich (DE); Christian WELK, Munich (DE); Michele CORONA, Munich (DE)

(21) Appl. No.: 18/572,291

(22) PCT Filed: Jun. 29, 2022
(86) PCT No.: PCT/EP2022/067817

§ 371 Date: Dec. 20, 2023

(30) Foreign Application Priority Data
Jun. 29, 2021 (LU) LU500348

(51) Int. Cl. G01S 7/292; G01S 7/527

(52) U.S. Cl. CPC G01S 7/2921; G01S 7/527

(57) ABSTRACT

The invention relates to a method for determining a transmission signal in at least one received signal (3, 4, 5), wherein the method has the following steps:
sending a transmission signal (1) via a transmitter (7),
receiving the signal (3, 4, 5), which contains at least part of the transmission signal, characterized in that
   to determine the transmission signal in the received signal (3, 4, 5), a time-dependent transmitter property value is used, which results from a physical structure of the transmitter (7).

The invention relates to a method for determining a transmission signal in at least one received signal, wherein the method comprises sending a transmission signal via a transmitter and receiving the signal that contains at least part of the transmission signal. In addition, the invention relates to the use of such a method in three-dimensional position determination and a device with a transmitter, at least one receiver.

Sensors are known from the prior art which have a transmitter that actively emits an ultrasonic wave and detects reflections from various objects that are in the field of view of the sensor by means of at least one receiver. In addition to reflecting the actively generated sound wave, the receiver also picks up ambient noise and other types of noise.

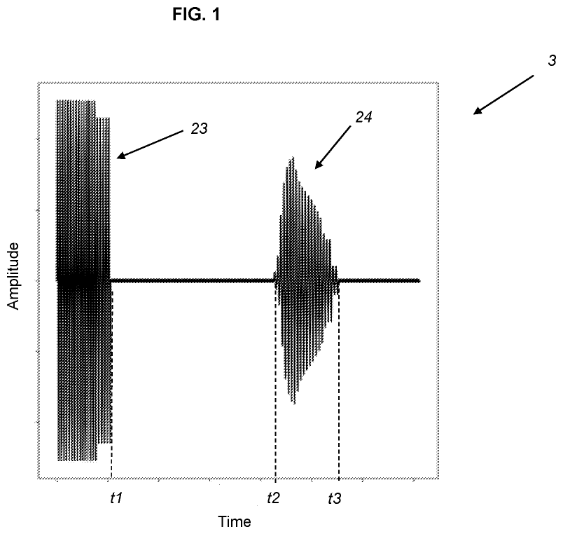

FIG. 1 shows a section of a signal 3 received via a receiver. In particular, FIG. 1 shows the amplitude curve of the received signal 3 over time, wherein the vertical axis represents the amplitude and the horizontal axis represents the time. A first signal section 23 received up to the first time t1 represents the emitted sound wave, which is recorded directly between the transmitter and receiver. A second signal section 24 received between a second time t2 and a third time t3 represents an interesting section of the received signal 3. The remaining portions of the received signal can be considered noise. The interesting section can be the reflection of the actively emitted sound wave or some other loud noise. It is therefore necessary to determine whether this section is a reflected sound wave or interference noise.

In known methods it is assumed that the actively emitted sound wave corresponds to the section of the received signal whose amplitude is greater than a predetermined threshold value. However, such a method has the disadvantage that it is inaccurate, in particular as loud ambient noises, i.e., noises with high amplitude, are incorrectly recorded as a reflected transmission signal.

The object of the invention is therefore to provide a method by means of which the transmitted signal can be precisely determined in the received signal.

The object is achieved by a method for determining a transmission signal in at least one received signal, wherein the method has the following steps:
sending a broadcast signal via a transmitter,
receiving the signal, which contains at least part of the transmission signal, characterized in that
to determine the transmission signal in the received signal, a time-dependent transmitter property value is used, which results from a physical structure of the transmitter.

A further object of the invention is to provide a device by means of which the transmitted signal can be determined in the received signal.

The object is achieved by a device with at least one transmitter for sending a transmission signal, at least one receiver for receiving a signal which contains at least part of the transmission signal, characterized in that the device has an evaluation device which uses a time-dependent transmitter property value, which results from a physical structure of the transmitter, to determine the transmission signal in the received signal.

According to the invention it was recognized that a transmitter has a time-dependent transmitter property value that results from a physical structure of the transmitter. By taking into account the transmitter property value, in particular transmitter property values, when determining the transmitted signal in the received signal, the transmitted signal in the received signal can be determined precisely and easily because it is thereby possible to identify at least a large part of the ambient noise as irrelevant components of the received signal.

The transmitter property value can be a parameter that can be measured directly or is determined indirectly by measuring physical variables. As mentioned previously, the transmitter property value results from the physical structure of the transmitter. In particular, the transmitter property value can depend on the arrangement and/or mass of the transmitter components. All grounded transmitters have a transmitter property value curve that is characteristic of the transmitter. The transmitter property value is not actively generated when the transmission signal is transmitted, i.e., consciously in addition to the transmission signal, but necessarily results from the physical structure of the transmitter and/or can be measured or determined using measured physical variables.

According to the invention, it was thus recognized that in the received signal it is necessary to search for a time period in which the transmitter property value curve can be found. This time period accordingly contains the transmission signal. In particular, the method can be used to detect signal sections that look like a transmission signal, in particular a reflected one, but are actually noise or interference. This is possible because these signal sections do not have the transmitter property value curve. As a result, it can be recognized exactly when a signal section of the received signal contains a transmission signal and when it does not.

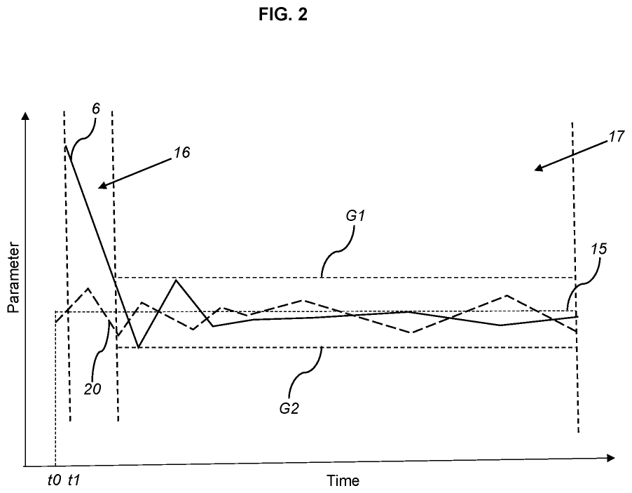

For a better understanding of the time-dependent transmitter property value, reference is made to FIG. 2. FIG. 2 shows the course of a control characteristic curve 15 of the transmitter over time at a predetermined frequency, wherein the control begins at time to. The control characteristic curve 15 is defined by several control characteristic values. In addition, a course of an expected signal 20 is shown in FIG. 2. It is expected that the receiver determines a signal 20 that has the same frequency as the control characteristic 15 and therefore levels off around the control characteristic curve 15. After a control period in which the transmitter was stimulated by an excitation signal, the frequency should continue to fall. However, this is not shown in FIG. 2.

In addition, FIG. 2 shows an actual received signal curve, which is measured by a receiver and is referred to below as the transmitter property value curve 6. It can be seen that the transmitter property value curve 6 has a significantly different curve from the expected signal curve 20, at least initially. The different frequency curve results from the above-mentioned physical structure of the transmitter and is transmitter-specific, therefore characterizing the transmitter. In other words, the transmitters can be distinguished from each other based on the transmitter property value curve.

The transmission signal can be a wave, in particular an electromagnetic wave, or a pressure wave, in particular a sound wave. The received signal can be a wave, in particular an electromagnetic wave, or a pressure wave, in particular a sound wave.

The transmitter can emit the transmission signal in all spatial directions or at least in a half-space. In particular, the transmitter can be a sound transmitter. In addition, the transmitter can have at least one piezo component by means of which the transmission signal can be generated. The receiver is designed to receive the transmission signals emitted by the transmitter, in particular the transmission signals that are at least partially reflected by the object.

In a particular embodiment, the transmitter can be controlled to generate the transmission signal using a predetermined number of control signals. Alternatively or additionally, the transmission signal can be output for a predetermined time period. The transmission signal is therefore not received continuously via the receiver or receivers, in particular during the entire receiving process. The predetermined time period during which the transmission signal is output is less than the time period during which the receiver or receivers receive signals. The transmitter can be controlled in such a way that the transmitted signal output has a sinusoidal curve. Alternatively, the transmission signal can have a rectangular shape.

The transmission signal can be at least partially reflected by an object. The receivers can receive the at least partially reflected transmission signal. In addition, the transmission signal can be transmitted directly to at least one receiver. In addition, the transmission signal can be received via at least one receiver without reflection, i.e., without the transmission signal being reflected by an object. The evaluation device therefore knows the time at which the transmission signal is sent. A “direct transmission” means that the device, in particular the transmitter, is configured such that the receiver receives a non-reflected transmission signal.

In addition, the evaluation device has been provided with the transmitter property values after receiving the transmission signal transmitted directly from the transmitter. The evaluation device can determine the transmitter property values, in particular, on the basis of the reflection-free transmission signal received by the receiver. By determining the transmitter property values using the evaluation device, the transmission signal in the received signal can be determined in a particularly precise manner. The transmitter property values can change over time due to wear and tear on the transmitter and/or can depend on the ambient temperature. The transmission of the transmission signal directly to the at least one receiver can take place each time the transmission signal is output by the transmitter. Alternatively, the transmission signal can be transmitted to the receiver at predetermined times.

The determination of the transmitter property values can be carried out in an identical manner to the determination of the analysis characteristic values described in detail below. The transmitter property values can be determined based on the transmission signal transmitted directly to the receiver.

The transmitter property values can be stored in an electrical storage device. In this way, the transmitter property values determined by the evaluation device can be stored in the electrical storage device. Alternatively, the transmitter property values can be determined before implementing the method. This can be done regardless of the device. In this case, the transmitter property values are not determined during the method. With such a design, the calculation effort for the evaluation device is reduced.

The transmitter property value can depend on a time period between two signal points of the determined signal. The transmitter property value can occur in phase and/or amplitude and/or frequency. If a frequency shift is chosen as a characterizing feature, the evaluation device determines a frequency curve of the received signal. To determine the frequency curve, clearly identifiable features of the wave can be used to determine an instantaneous frequency value even for a time period shorter than a full oscillation (360°).

A method in which the transmission signal is not modulated, in particular directly, by the control signal is particularly advantageous. Likewise, the received signal cannot be modulated. In particular, there is no frequency and/or amplitude modulation of the transmitted signal and/or the received signal. This avoids time-consuming calculations in the evaluation device. The evaluation device can be a processor or have at least one processor.

The device can have a housing, wherein the evaluation device can be arranged in an interior of the housing. The at least one receiver and the transmitter can be mechanically connected to the housing. The evaluation device can carry out the necessary method steps when determining the transmission signal.

In a particular embodiment, when determining the transmission signal in the received signal, an amplitude value of the received signal can be compared with a predetermined threshold value. This makes it simple to determine sections of the received signal that most likely do not contain any signals that can be evaluated. These sections are not taken into account during the further determination of the transmission signal in the received signal, as a result of which the reflected transmission signal in the received signal is determined with little resource expenditure and at high speed. In particular, the determination of the transmitted signal can be continued in the received signal when the amplitude value is greater than the threshold value. On the other hand, the determination of the transmitted signal in the received signal can be ended when the amplitude value is smaller than the threshold value. The threshold value can be predetermined depending on the area of application of the device.

In a particular embodiment, the received first signal can be divided into several signal sections. The signal sections have the same phase angle range. The phase angle range can be 90°, 180° or 360°. However, other phase angle ranges are also possible. In particular, the phase angle range has a phase angle of at most 360°. The individual signal sections are arranged offset from one another, particularly in terms of time.

The evaluation device can determine a curve function of the signal section, in particular of each signal section. The course of the signal section can be determined by at least one algorithm. As already described above, the transmission signal can have a sinusoidal curve. This makes it particularly easy to determine the course of the signal section.

The evaluation device can determine at least two signal points in the received signal. In particular, the evaluation device can determine one or more signal points in the signal section. It is particularly preferred if the evaluation device can determine one or more signal points in each signal section. The determination of the signal points is possible in a simple manner if, as described above, the curve function of the further signal section is known.

In addition, the evaluation device can determine a time assigned to the signal point. When determining several signal points, the evaluation device can determine the time assigned to the signal point for each signal point. This makes it easy to know at what time the respective signal point is present.

The signal points can be arranged offset from one another, in particular by a predetermined phase angle. Alternatively or additionally, the at least two signal points can each be arranged offset from a reference point by a predetermined phase angle. In addition, the signal points are arranged offset from one another in terms of time.

The signal point can be a point that characterizes the course of the signal section. The signal point can be a maximum, a minimum or a turning point of the signal section. Alternatively or additionally, a signal point can be any point of the signal section with a predetermined phase angle or a predetermined phase angle difference to another signal point or a reference point.

The same number of signal points can be determined in each signal section. The signal points can be determined in such a way that a signal point determined in a first signal section and a signal point determined in a second signal section have the same phase angle. In other words, the same signal points can be determined in the individual signal sections. The first signal section and the second signal section are offset from one another in terms of time. In particular, the second signal section comes after the first signal section.

In the event that the signal sections have a phase angle range of 0 to 360°, the first signal section and the second signal section are directly adjacent. This means that the second signal section directly follows the first signal section. In the event that the signal sections have a phase angle range smaller than 360°, at least one intermediate signal section is arranged between the first and second signal sections. In particular, an intermediate signal section can come between the first and second signal sections if the signal sections comprise a phase angle of 180°. The first signal section comprises a phase angle range of 0 to 180° and the intermediate signal section comprises a phase angle range of 180 to 360°. It is clear that there are no signal points with the same phase angle in the first signal section and the intermediate signal section.

In a particular embodiment, the evaluation device can determine at least one analysis characteristic value, in particular several analysis characteristic values, on the basis of the received signal. The analysis characteristic values differ from the received signal values. The determination of the analysis characteristic values is described below.

The analysis characteristic values can be generated based on the times assigned to the determined signal points. In particular, the analysis characteristic values can be determined on the basis of the determined signal points, in particular on the basis of the times assigned to the determined signal points. An analysis characteristic value can be determined particularly easily if the analysis characteristic value depends on a time period of a pair of signal points.

The time period for a pair of signal points can depend on a time associated with one signal point and another time associated with another signal point. In particular, the time period can correspond to a time difference between the time assigned to a signal point and the other time assigned to another signal point. It is particularly advantageous if the signal point and the other signal point are adjacent to one another. Adjacent is understood to mean that the signal point and the other signal point are offset from one another in terms of time and there are no further signal points between the two signal points.

In a particular embodiment, when determining the transmission signal in the received signal, at least one analysis characteristic value can be analyzed using at least one transmitter property value. In particular, the analysis can check whether at least one analysis characteristic value, in particular several analysis characteristic values, corresponds to at least one transmitter property value, in particular several transmitter property values, or is in a predetermined range. The predetermined range includes the transmitter property values and is limited by a predetermined upper and a predetermined lower limit. In addition, an analysis characteristic value curve can be used to determine the transmission signal in the received signal. As a result, the analysis characteristic value can be determined in a simple manner by using at least one of the aforementioned options.

The evaluation device can determine that a time period, in which several analysis characteristic values correspond to several transmitter property values or are in a predetermined range around the transmitter property values, is a time period of the received signal in which the received signal contains the transmission signal.

Alternatively or additionally, a time period in which an analysis characteristic value curve, in particular for a predetermined time period, points in the same direction as a transmitter property value curve can be determined as a time period of the received signal in which the received signal contains the transmission signal. The analysis characteristic value curve and the transmitter property value curve point in the same direction if a gradient of an analysis characteristic value curve and a transmitter property value curve is positive or negative, in particular during the predetermined time period. The analysis characteristic curve and the transmitter property value curve can have the same gradient. However, this is not absolutely necessary. On the other hand, the analysis characteristic value curve and the transmitter property value curve do not point in the same direction if the analysis characteristic value curve has a positive gradient and the transmitter property value curve has a negative gradient or vice versa. As a result, by checking the analysis characteristic value curve and/or the presence of the analysis characteristic values in the predetermined range, it can be easily determined whether the received signal contains the transmitted signal.

In a particular embodiment, at least one control characteristic value, in particular several control characteristic values, can be used when determining the, in particular reflected, transmission signal in the received signal. The control characteristic value can be a time-dependent control frequency of the transmitter. The control frequency can be constant. The control characteristic value can depend on the phase angle difference of the signal points.

When determining the transmission signal, it can be checked whether analysis characteristic values deviate from the control characteristic value in a first time period and approach the control characteristic value, in particular continuously. Approaching is understood here to mean that the amount of the analysis characteristic values runs in the direction of the amount of the control characteristic value, i.e., has a decreasing or increasing course. When considering a control characteristic curve that is determined by the control characteristic values, the control characteristic curve runs in the direction of the control characteristic value.

In addition, a first distance between a control characteristic value and the transmitter property value can be determined at least at a predetermined time. In addition, it can be checked whether at the predetermined time a second distance between the analysis characteristic value and the control characteristic value is equal to the first distance or lies in a predetermined range around the first distance. The time can be chosen such that it is assigned to a maximum of the analysis characteristic values in a first time period. In addition, it can be checked whether analysis characteristic values in the first time period are in a predetermined range that includes the transmitter property values. In addition, the evaluation device for determining the transmission signal in the received signal can check whether, in the first time period, the analysis characteristic value curve, in particular for a predetermined time period, points in the same direction as the transmitter property value curve. This takes advantage of the fact that in the first section the transmitter property value curve differs significantly from the control characteristic curve and this area can therefore be easily discovered.

In addition, it can be checked whether analysis characteristic values for a predetermined time in a second section period are within a predetermined range that has transmitter property values. The specified range can be around the control characteristic values. Alternatively, the predetermined range can be offset from the control characteristic values, in particular by a predetermined distance. The predetermined range may depend on the transmitter property values. To determine the predetermined range, the fluctuation of the transmitter property values, can be determined in particular around the control characteristic values. An upper limit and a lower limit of the predetermined range can depend on the fluctuation of the transmitter property values, in particular around the control characteristic values. In particular, the maximum fluctuation of the transmitter property values, in particular of the control characteristic values, can be used to determine the upper and/or lower limit.

It is particularly advantageous if the period of the second section corresponds to the time period of a control period of the transmitter. The time period of the transmitter's control period is known so that a time period in the received signal that corresponds to the transmitted signal can be easily determined. By focusing on the time period of the transmitter's control period, the accuracy of the determination is improved.

The evaluation device can determine that a time period of the received signal corresponds to the transmission signal when analysis characteristic values in the first time period of the time period deviate from control characteristic values and approach the control characteristic values, and when analysis characteristic values in the second time period of the time period, which is adjacent to the first time period, in particular directly, are within the predetermined range, in particular around the control characteristic values.

In addition, the evaluation device can determine that a time period of the received signal corresponds to the transmission signal when, in the first time period, the analysis characteristic value curve, in particular for a predetermined time period, points in the same direction as the transmitter property value curve, and when analysis characteristic values in the second time period of the time period, which is adjacent to the first time period, in particular directly, are within the predetermined transmitter characteristic curve, in particular for a predetermined time period. When analyzing the analysis characteristic curve, a time period can first be determined in which the conditions to be present in the second time period are fulfilled. It can then be checked whether, before the second time period, there is a first time period in which the condition present in the first time period is fulfilled.

The time period of the received signal, in which the received signal contains the transmission signal, corresponds to a time period composed of the first time period and the second time period.

The first time period can be shorter in time than the second time period. In particular, a maximum of the analysis characteristic values in the first time period can be greater than a maximum of the analysis characteristic values in the second time period. In addition, a minimum of the analysis characteristic values in the first time period can be smaller than a minimum of the analysis characteristic values in the second period.

When carrying out the method, the evaluation device can examine the received signal to see whether it has a first time period in which the analysis characteristic value curve points in the same direction as the transmitter property value curve. The evaluation device can then check whether there is a second time period directly following the first time period in which the above-mentioned condition, namely that the analysis characteristic values, in particular for a predetermined time period, are in the predetermined range that has the transmitter property values, is met.

Alternatively, when executing the method, the evaluation device can first examine the received signal to see whether there is a second time period in which the above-mentioned condition is met. In addition, the evaluation device checks whether there is a first time period before the second time period in which the above-mentioned condition is met.

The first time period is understood to be a section of the time period in which the analysis characteristic values deviate from the control characteristic values and approach the control characteristic values. In addition, the analysis characteristic values in the first time period are arranged outside the predetermined range of the second time period. The predetermined time period within which the analysis characteristic value curve points in the same direction as the transmitter property value curve can be determined by analyzing the transmitter property value curve. As described above, two time periods with different courses can also be determined for the transmitter characteristic curve. By looking at the first time period of the transmitter property value curve, the predetermined time period within which the transmitter property value curve increases can be determined. The time period corresponds to a rising course starting from a minimum up to the second time period in which the analysis characteristic value lies within the predetermined range, or a falling course starting from a maximum up to the second time period in which the analysis characteristic value is within the predetermined range.

In a particular embodiment, if it is determined that a time period of the received signal contains the transmitter signal, the time at which the analysis characteristic values have their maximum in the determined time period of the received signal can be determined. Since the time at which the transmission signal is sent is known, the distance of the object from the receiver can be determined using the time difference. The method therefore utilizes the transmitter property value curve in order to be able to determine the start of a reflection more precisely. When using three receivers, the three-dimensional position determination can be carried out in a particularly simple and precise manner.

The device can have several receivers, in particular exactly three receivers, each of which receives a signal. The evaluation device can determine the transmission signal using the transmitter parameter curve for each signal received by the, in particular three, receivers. The distance between the receivers or receiver groups, each of which has several receivers, can be a maximum of half a wavelength of the received signal. In particular, the distance between the receivers can be less than half a wavelength of the received signal. Alternatively or additionally, the distance between the receivers can be a maximum of half a wavelength of the transmission signal and/or the relevant frequency range of the received signal, wherein the frequency range of the received signal can be dependent on the transmission signal and the transmitter properties.

For determining a three-dimensional position, the transmitter and one receiver or two or more than two receivers can be arranged in a straight line. The third receiver is arranged in such a way that it is not arranged in a straight line. The transmitter and all receivers lie in a plane that has the straight line. The object is arranged such that it is spaced at a distance from the plane. In other words, the object is not located on the plane. The transmitter can act as one of the receivers after sending out the transmission signal. This means that the transmitter can send the transmit signal as well as receive signals.

It is particularly advantageous if the method according to the invention is used in three-dimensional position determination, in particular by means of the device described above.

The subject matter of the invention is shown schematically in the figures, wherein elements that are the same or have the same effect are usually provided with the same reference symbols. In the figures:

FIG. 1 shows a course of a received signal,

FIG. 2 shows a transmitter property value curve,

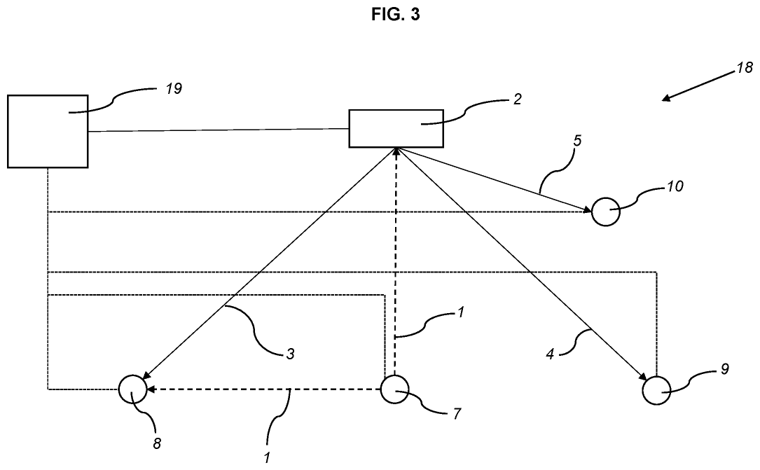

FIG. 3 shows a device for determining a transmission signal in the received signal shown in FIG. 1,

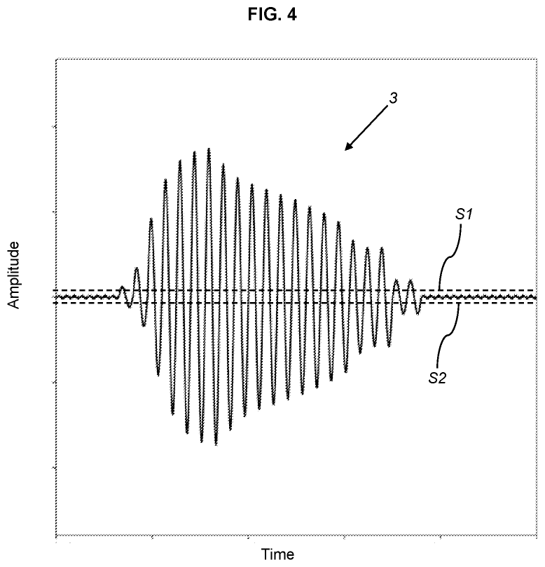

FIG. 4 shows an enlarged section of the received signal shown in FIG. 1,

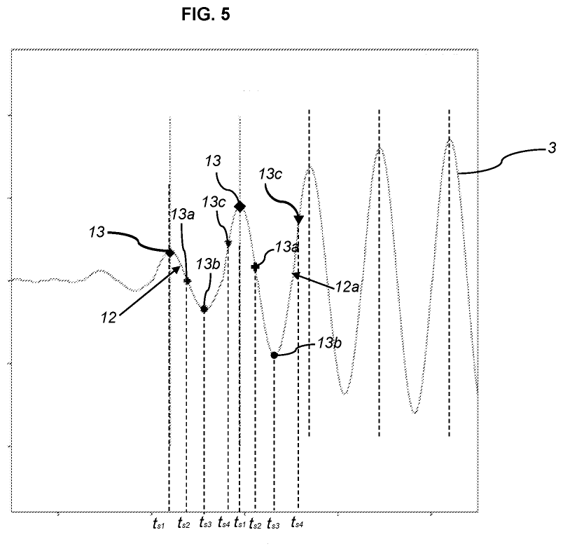

FIG. 5 shows an enlarged section of the signal shown in FIG. 4 with signal sections

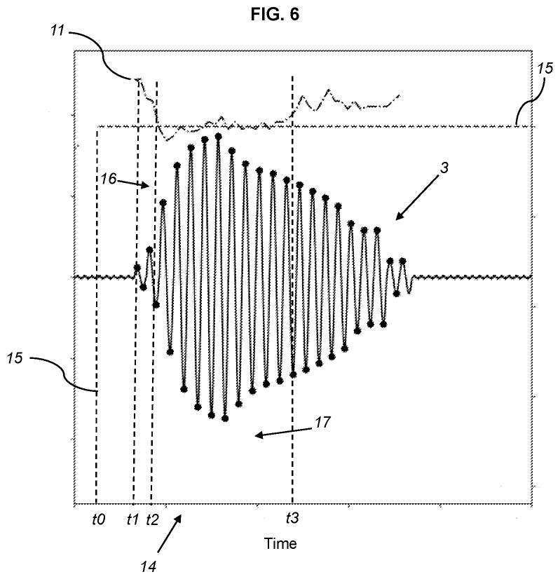

FIG. 6 shows an analysis characteristic curve and the signal shown in FIG. 3 for a case in which a transmission signal can be determined in the received signal,

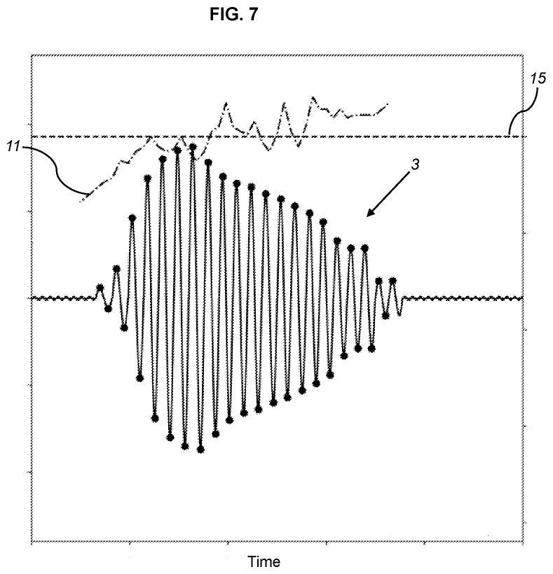

FIG. 7 shows an analysis characteristic curve and the signal shown in FIG. 3 for a case in which no transmission signal is determined in the received signal,

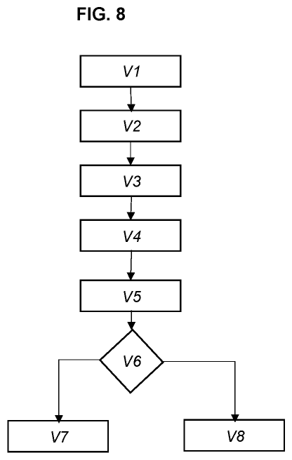

FIG. 8 shows a flowchart for determining the transmission signal in the received signal.

FIG. 3 shows a device 18 for determining a reflected signal in a received signal 3, 4, 5 which has a transmitter 7 and three receivers 8, 9, 10, namely a first receiver 8, a second receiver 9 and a third receiver 10. In addition, the device 18 has an evaluation device 19, which is connected in terms of data technology to the transmitter 7 and each of the receivers 8, 9, 10. The data connection is shown in dashed lines in FIG. 3.

The transmitter 7 sends a transmission signal 1 to the environment. The transmission signal 1 is reflected on an object 2 that does not form part of the device 18. The first receiver 8 receives a first signal 3, the second receiver 9 receives a second signal 4 and the third receiver 10 receives a third signal 5. Each of the signals 3, 4, 5 received in FIG. 3 contains the reflected part of the transmission signal 1. However, the received signals also contain noise, such as ambient noise, which do not originate from the object 2. The transmitter 7 also sends a transmission signal 1 directly to the first receiver 8. This means that this transmission signal 1 is not reflected by the object 2.

The method according to the invention is explained below using the example of a single received signal 3, 4, 5. For reasons of simplification, the first signal 3 received by the first receiver is used. However, the evaluation device 19 also applies the method to the signals 4, 5 received from the second receiver 9 and the third receiver 10.

After the transmitter 7 has sent out a transmission signal 1, the first receiver 8 receives the first signal 3 shown in FIG. 1. The first signal section 23 corresponds to the transmission signal 1 transmitted by the transmitter 7 directly to the first receiver 8. In a second signal section 24 in the time t2 to t3, an increase in amplitude of the received first signal 3 can be determined so that it can be assumed that the signal reflected by the object 2 is contained in the second signal section 24. Since the period t2 to t3 is longer than a time period of a control period of the transmitter 7, in which the transmitter 7 is supplied with a control signal, it must be determined which section of the second signal section 24 contains the reflected transmission signal. This is explained in more detail below.

As described above, the transmitter 7 sends the transmission signal 1 directly to the first receiver 8. The evaluation device 19 generates the transmitter property value curve 6 shown in FIG. 2 in the device 18 shown in FIG. 3 on the basis of this transmission signal 1. The transmitter property value curve 6 is determined by several transmitter property values. In addition, the transmitter property value curve 6 is determined in an analogous manner to the analysis characteristic value line 11 described in more detail below and shown in FIGS. 6 and 7. Alternatively, the transmitter property value curve 6 can be stored in an electrical storage device of the device 18.

The transmitter property value curve 6 has a decreasing curve in a first time section 16 and runs at a second distance 17 around a control characteristic curve 15. The control characteristic 15 can be a control frequency with which the transmitter 7 is controlled to emit the transmitter signal 1. The controlling of the transmitter begins at time to. The evaluation device 19 determines an upper and a lower limit value G1, G2 around the control characteristic curve 15 so that the transmitter property value curve 6 runs in the predetermined range generated by the upper and lower limit values G1, G2 in the second time period. In an alternative embodiment, not shown, the predetermined area can be arranged offset from the control characteristic curve 15. The upper and lower limit values are set so that the transmitter property value curve 6 lies within the predetermined range. Alternatively, the upper and lower limit values can be fixed. As can be seen from FIG. 2, the first time period 6 corresponds to the area in which the transmitter property value curve 6 runs above the upper limit value G1 and runs above the control characteristic curve 15. In addition, the transmitter property value curve falls in the first time period in the direction of the control characteristic curve 15.

FIG. 4 shows an enlarged section of the received signal 3 shown in FIG. 1. As can be seen from FIG. 4, the signal has a, in particular essentially sinusoidal, course. An upper threshold value S1 and a lower threshold value S2 are also shown in FIG. 4.

FIG. 5 shows an enlarged section of the signal 3 shown in FIG. 4. The evaluation device 19 divides the received first signal 3 into several signal sections 12, 12a. The individual signal sections 12, 12a comprise the same phase angle range. In particular, the signal sections include a phase angle range from 0° to 360°. The signal sections 12, 12a are offset from one another in terms of time.

In FIG. 5, explicit reference is made to two signal sections, namely a first signal section 12 and a second signal section 12a. The evaluation device 9 can also have several signal sections 12, 12a. In particular, the evaluation device 9 can divide the entire received signal 3, 4, 5 into signal sections 12, 12a. The individual signal sections 12, 12a are analyzed in order, for example, to determine a curve function that reflects the course of the signal section 12, 12a.

The evaluation device 18 determines at least one signal point 13, 13a, 13b, 13c in each signal section 12, 12a. In the present case, the evaluation device 19 determines four signal points in a first signal section 12 and a second signal section 12a, namely a first signal point 13, a second signal point 13a, a third signal point 13b and a fourth signal point 13c. The first signal point 13 is a maximum of the signal section 12, 12a, the second signal point 13a is a turning point of the signal section 12, 12a, the third signal point 13b is a minimum of the signal section 12, 12b and the fourth turning point 13c is a point with a predetermined phase angle difference to one of the previous signal points.

The evaluation device 19 determines the same signal points 13, 13a, 13b, 13c in each signal section 12, 12a. This means that signal points 13, 13a, 13b, 13c which have the same phase angle are determined in each signal section 12, 12a. The signal points 13, 13a, 13b, 13c are arranged offset from one another along the received signal.

The determined signal points 13, 13a, 13b, 13c are used to determine an analysis curve 11 shown in FIG. 6. For this purpose, the evaluation device 19 determines the time ts1 to ts4 assigned to the signal point 13, 13a, 13b, 13c for each signal point. The analysis characteristic values and thus the analysis characteristic curve 11 depend on a time interval between two signal points. The analysis characteristic curve 11 is determined by determining the time period between two adjacent signal points along the signal 3. In the present case, a time period between the first signal point 13 and the second signal point 13a, a time period between the second signal point and the third signal point, and a time period between the third signal point and the fourth signal point are determined in the first signal section 12. In addition, a time period between the fourth signal point and the first signal point of the second signal section 12a is determined. The time period corresponds to a time difference between the respective times ts1 to ts4 assigned to the signal points.

FIG. 6 shows an analysis characteristic curve 11 and the signal shown in FIG. 3 for the case where a reflected transmission signal can be determined in the received first signal 3, and FIG. 7 shows an analysis characteristic curve 11 and the signal shown in FIG. 3 for the case where no transmission signal is present in the received first signal 3, and therefore cannot be determined. In addition, FIGS. 6 and 7 show the control characteristic curve 15, wherein the controlling begins at time to. In contrast to the signal 3 shown in FIG. 5, in the first signal 3 shown in FIG. 6, only two signal points, namely the maximum and the minimum of the respective signal section, are determined in the signal sections. The analysis characteristic curve 11 is thus determined by determining the time interval between the maxima and minima of the determined signal 3, 4, 5.

FIG. 8 shows a flow chart for determining the reflected transmission signal in the received signal 3. In a first step V1, the transmission signal 1 is sent out, wherein the transmission signal 1 is also transmitted directly to the first receiver 8. The first receiver 8 receives a signal 3 which contains part of the transmission signal 1 reflected by the object 2. The evaluation device 19 determines the transmission time at which the transmitter 7 sent out the transmission signal based on the transmission signal 1 received directly from the first receiver 8.

In a second step V2, the evaluation device 19 determines the transmitter property value curve 6. The determination is carried out analogously to the determination of the analysis characteristic curve 11 described above. This means that the evaluation device 19 divides the transmission signal 1 received directly from the transmitter 7 into signal sections, determines signal points and subsequently determines the time difference between the signal points. In addition, the predetermined range is determined using the upper and lower limits G1, G2 in which the transmitter property values are found. The evaluation device determines that in the first time period, which comes directly before the second time period, the transmitter property value curve decreases, i.e., has a negative gradient. The second step V2 is omitted if the transmitter parameter curve 6 is stored in an electrical storage device of the device 18. After completion of the second step V2, the evaluation device 9 knows that a transmission signal is present if the analysis characteristic curve 11 lies in the predetermined range for a predetermined time period and if a first portion coming before the second time period has a falling range. The predetermined period can, in particular, depend significantly on the control period of the transmitter. In addition, the predetermined time period can depend on the structure of the transmitter and/or the temperature and/or a bias voltage in the transmitter and/or a mechanical tension in the transmitter and/or vibrating masses of transmitter components.

In a third step V3, the section of the received first signal 3 is determined, the amplitude of which is outside the range limited by the upper and lower threshold values S1 and S2. This section will be processed below. The remaining part of the first signal 3 is not taken into account and is viewed as noise which is of no interest.

In a fourth step V4, the received signal is divided into signal sections 12 and the signal points 13, 13a, 13b, 13c and the times ts1 to ts4 assigned to the signal points are determined. In addition, the analysis characteristic curve 11 is determined in the fourth step S4.

In a fifth step V5, the analysis characteristic curve 11 is examined to see whether it comprises the transmitter property value curve 6. For this purpose, it is checked whether the analysis characteristic curve 11 comprises the second time section 17 of the transmitter property value curve 6. In particular, it is checked whether a range of the analysis characteristic curve 11 exists in which the analysis characteristic curve 11 is within the predetermined range limited by the upper limit value G1 and the lower limit value G2 for the predetermined time period. As can be seen from FIG. 6, this is the case in a time period t2 to t3, which corresponds to the second time period. The time period is also longer than a predetermined time period, which can depend on the time period of the control.

It is then checked whether a course of the analysis characteristic curve 11 in a region before time t2 points in the same direction as the transmitter property value course. This is the case with the course of the analysis characteristic curve 11 shown in FIG. 6. The analysis characteristic value curve has a maximum at time t1 and then has a decreasing course up to the second section 17, analogous to the transmitter property value curve. Thus, in the time t1 to t2, the course of the analysis characteristic curve 11 corresponds to the transmitter property value course 6.

In a sixth step V6 it is checked whether both conditions are met. If this is the case, it is determined in a seventh step V7 that the reflected transmission signal is contained in the received first signal 3. In particular, the time period 14 of the received signal is determined in which the conditions are met. This is the case in the embodiment shown in FIG. 6 between times t1 to t3. The time period 14 therefore corresponds to the time period between times t1 to t3.

If, on the other hand, it is determined in the sixth step V6 that one or neither of the two conditions is fulfilled, it is determined in the eighth step V8 that the reflected transmission signal cannot be determined in the received signal. This is the case in the embodiment shown in FIG. 7. In this embodiment, there is no time period in which both conditions are met. In particular, in the embodiment shown in FIG. 7, there is no second time period in which the analysis characteristic curve is within the range predetermined by the upper and lower limit values for at least a predetermined time period. In addition, the analysis characteristic value curve 11 rises in the first area, i.e., has a positive gradient, while, as can be seen from FIG. 2, in the present case the transmitter property value curve falls in the first time period, i.e., has a negative gradient.

### LIST OF REFERENCE SYMBOLS

1 Transmission signal
2 Object
3 Received first signal
4 Received second signal
5 Received third signal
6 Transmitter property value curve
7 Transmitter
8 First receiver
9 Second receiver
10 Third receiver
11 Analysis characteristic curve
12 First signal section
12a Second signal section
13 First signal point
13a Second signal point
13b Third signal point
13c Fourth signal point
14 Time period of the received signal
15 Control characteristic curve
16 First section of the analysis characteristic curve
   17 Second section of the analysis characteristic curve
   18 Device
   19 Evaluation device
   20 Expected frequency curve
   23 First signal section
   24 Second signal section
   G1 Upper limit value
   G2 Lower limit value
   S1 Upper threshold value
   S2 Lower threshold value

1.-31. (canceled)

32. A method for determining a transmission signal in at least one received signal, wherein the method comprises:
sending a transmission signal via a transmitter,
receiving the signal, which contains at least part of the transmission signal,
wherein to determine the transmission signal in the received signal, a time-dependent transmitter property value is used, which results from a physical structure of the transmitter.

33. The method according to claim 32, wherein:
a. the time-dependent transmitter property value is stored in a storage device; and/or
b. the time-dependent transmitter property value is a frequency or depends on a time period between two signal points of the transmission signal transmitted to at least one receiver; and/or
c. the received signal is not modulated; and/or
d. the time-dependent transmitter property value is determined on the basis of the transmission signal transmitted to at least one receiver.

34. The method according to claim 32, wherein to determine the transmission signal in the received signal, an amplitude value of the received signal is compared with a predetermined threshold value.

35. The method according to claim 32, wherein the received signal is divided into several signal sections.

36. The method according to claim 35, wherein:
a. a curve function of the respective signal section is determined; and/or
b. the signal sections have the same phase angle range.

37. The method according to claim 35, wherein one or more signal points are determined in the signal section.

38. The method according to claim 37, wherein:
a. a time assigned to the signal point is determined; and/or
b. a number of determined signal points in the signal sections is the same; and/or
c. multiple signal points are determined, wherein the signal points are arranged offset from one another and/or are arranged offset from a reference point by a predetermined phase angle.

39. The method according to claim 37, wherein:
a. a signal point determined in a first signal section and a signal point determined in a second signal section have the same phase angle; and/or
b. a first signal section and a second signal section are offset from one another in terms of time.

40. The method according to claim 32, wherein at least one analysis characteristic value is determined:
a. on the basis of the received signal; and/or
b. on the basis of the determined signal points.

41. The method according to claim 40, wherein the at least one analysis characteristic value depends on at least one time period of a pair of signal points, wherein to determine the time period of the pair of signal points, a difference is determined between a time assigned to a signal point and another time assigned to another signal point.

42. The method according to claim 40, wherein:
a. for determining the transmission signal in the received signal, the analysis characteristic value is analyzed using the transmitter property value; and/or
b. to determine the transmission signal in the received signal, it is checked whether at least one analysis characteristic value corresponds to at least one transmitter property value or is in a predetermined range which has the at least one transmitter property value; and/or
c. an analysis characteristic value curve is used to determine the transmission signal in the received signal.

43. The method according to claim 40, wherein a time period is determined as the time period of the received signal, in which the received signal contains the transmission signal, wherein in the time period:
a. several analysis characteristic values correspond to several transmitter property values or are in a predetermined range that contains the transmitter property values; and/or
b. an analysis characteristic value curve points in the same direction as a transmitter property value curve.

44. The method according to claim 32, wherein at least one control characteristic value of the transmitter is used to determine the transmission signal in the received signal.

45. The method according to claim 44, wherein:
a. the control characteristic value is a control frequency of the transmitter; and/or
b. the control characteristic value depends on a phase angle difference of the signal points; and/or
c. when determining the transmission signal in the received signal, it is checked whether analysis characteristics deviate from the control characteristic value in a first time period and approach the control characteristic value; and/or
d. when determining the transmission signal in the received signal at least at a predetermined time, a first distance between a control characteristic value and the transmitter property value is determined and it is checked whether at the predetermined time a second distance from an analysis characteristic value to the control characteristic value is equal to the first distance or is in a predetermined range around the first distance.

46. The method according to claim 32, wherein:
a. to determine the transmission signal in the received signal, it is checked whether analysis characteristic values in a first time period are in a predetermined range that comprises transmitter property values; and/or
b. to determine the transmission signal in the received signal, it is checked whether analysis characteristic values in a second time period for a predetermined time lie within a predetermined range that comprises transmitter property values; and/or
c. to determine the transmission signal in the received signal, it is checked whether, in a first time period, an analysis characteristic value curve points in the same direction as a transmitter property value curve.

47. The method according to claim 46, wherein:
a. the time depends on a duration of a control period of the transmitter; and/or
b. the predetermined range depends on the transmitter property values.

48. The method according to claim 46, wherein it is determined that a time period of the received signal contains the transmission signal when:
a. analysis characteristic values in the first time period of the time period deviate from control characteristic values and approach the control characteristic values and when analysis characteristic values in the second time period of the time period, which is adjacent to the first time period, are within the predetermined range; and/or
b. in the first time period the analysis characteristic value curve points in the same direction as the transmitter property value curve, and when analysis characteristic values in the second time period of the time period, which is adjacent to the first time period, are within the predetermined range.

49. The method according to claim 46, wherein:
a. a maximum of the analysis characteristic values in the first time period is greater than a maximum of the analysis characteristic values in the second time period and/or a minimum of the analysis characteristic values in the first time period is smaller than a minimum of the analysis characteristic values in the second period; and/or
b. in the event that it is determined that a time period of the received signal contains the transmission signal, the time is determined in which a maximum or minimum of the analysis characteristic values is present in the determined time period of the received signal.

50. A device configured to carry out the method of claim 32, the device comprising:
at least one transmitter for sending a transmission signal;
at least one receiver for receiving a signal which contains at least part of the transmission signal; and
an evaluation device which uses a time-dependent transmitter property value, which results from a physical structure of the transmitter, to determine the transmission signal in the received signal.

51. The device according to claim 50, wherein:
a. the device has multiple receivers, each of which receives a signal, and for each received signal the evaluation device determines the transmission signal using the time-dependent transmitter property value; and/or
b. a distance between the receivers is at most half a wavelength of the received signal; and/or
c. the transmitter is configured such that the transmission signal is a sound wave or an electro-magnetic wave.
